(19) United States
(12) Patent Application Publication
(10) Pub. No.: US 2026/0240171 A1
(43) Pub. Date: Aug. 20, 2026

(54) BACTERICIDAL COMPOSITION COMPRISING BACILLUS VELEZENSIS TCS001 AND USE THEREOF

(71) Applicant: ZHEJIANG A & F UNIVERSITY, Hangzhou (CN)

(72) Inventors: Jie CHEN, Hangzhou (CN); Yaqin JIANG, Hangzhou (CN); Jing YUAN, Hangzhou (CN); Xiaohui HUANG, Hangzhou (CN); Feng CUI, Hangzhou (CN); Jing CHEN, Hangzhou (CN)

(73) Assignee: ZHEJIANG A & F UNIVERSITY, Hangzhou (CN)

(21) Appl. No.: 19/653,500

(22) Filed: Apr. 21, 2026

Related U.S. Application Data
(63) Continuation of application No. PCT/CN2024/130871, filed on Nov. 8, 2024.

(30) Foreign Application Priority Data
Nov. 15, 2023 (CN) 202311517524.3
Nov. 15, 2023 (CN) 202311517551.0

(51) Int. Cl. A01N 63/22; A01N 43/40; A01N 63/25; A01P 3/00; A01P 21/00

(52) U.S. Cl. CPC A01N 63/22; A01N 43/40; A01N 63/25; A01P 3/00; A01P 21/00

(57) ABSTRACT

Disclosed herein is a microbiocidal composition, including active ingredients Bacillus velezensis TCS001, boscalid, and Paenibacillus polymyxa HY96-2, where a mass ratio of Bacillus velezensis TCS001 to boscalid is 100:1 to 1:100, and a mass ratio of Bacillus velezensis TCS001 to Paenibacillus polymyxa HY96-2 is 50:1 to 1:50. The microbiocidal composition of this disclosure provides a novel alternative agent for controlling strawberry gray mold, which not only solves the problem of low control efficacy when Bacillus velezensis TCS001 is used alone, but also fully utilizes the disease resistance and immune function of Bacillus velezensis TCS001. Furthermore, through mixed use with boscalid, the development of resistance to boscalid can be delayed or reduced, producing an unexpected synergistic effect. The microbiocidal composition of this disclosure further provides a novel alternative agent for controlling strawberry anthracnose, and the combination of Bacillus velezensis TCS001 and Paenibacillus polymyxa HY96-2 has a synergistic effect in controlling strawberry anthracnose.

### TECHNICAL FIELD

This disclosure relates to the field of plant protection and, in particular, to a microbiocidal composition containing Bacillus velezensis TCS001, boscalid, and Paenibacillus polymyxa HY96-2, and use thereof for effectively controlling strawberry gray mold to improve strawberry traits, as well as use thereof for controlling strawberry anthracnose to improve the yield of strawberry seedlings and fruits.

### BACKGROUND

Currently, strawberry gray mold is a major disease affecting strawberry production. It occurs in various strawberry cultivation areas in China, and is particularly severe in the south where the harvest season coincides with the spring rainy season. The occurrence of strawberry gray mold often leads to rotting of flowers and fruits, greatly affecting strawberry yield and quality. Particularly in recent years, the development of certain resistance to pesticides has led to a yield reduction of about 10% in normal years and up to about 40% in epidemic years. Currently, chemical agents are commonly used for controlling strawberry gray mold, which poses a risk of pesticide residues. Therefore, there is an urgent need to develop a pesticide with high efficiency and low toxicity.

Bacillus velezensis is a novel biocontrol bacterium. In 2005, Spanish scholars Ruiz-García et al. first isolated two strains, CR-14b and CR-502T, which were found to be capable of synthesizing a large amount of lipopeptide substances and exhibit strong microbicidal activity. Bacillus velezensis is widely distributed and can survive under adverse conditions such as drought and salinity. However, there are very few related products, indicating a promising future for its development.

Bacillus velezensis TCS001 was isolated from Bohai Sea silt. The original strain was marine Bacillus CT2628, which was identified and named Bacillus velezensis TCS001 after being stabilized by mutagenesis. It has been deposited at the China General Microbiological Culture Collection Center (CGMCC) with accession number CGMCC No. 8921 and was first disclosed in patent ZL201410168402.2. After growth on an NA medium, single colonies of TCS001 appear nearly circular, pale yellow, and opaque; in the early stage of culture, the colony surface is smooth with neat edges, while in the later stage, the surface becomes wrinkled with slightly irregular edges and a raised center, and the periphery exhibits a cloud-like diffusion. Gram staining showed that Bacillus velezensis TCS001 was Gram-positive and rod-shaped, and exhibited certain inhibitory effects against pathogens causing gray mold, gummy stem blight, Sclerotinia rot, and brown spot in cucumbers, Fusarium wilt in cotton, and leaf spot in bananas, with the highest inhibition rate against cucumber gray mold, reaching 87.66%.

Boscalid is a mitochondrial respiratory inhibitor, classified as a succinate dehydrogenase inhibitor (SDHI). It acts by inhibiting succinate coenzyme Q reductase in the mitochondrial electron transport chain, and its mechanism of action is similar to that of other amide and benzamide fungicides. It has an effect on the entire growth process of pathogens, with particularly strong inhibitory effects on spore germination. Boscalid has a broad spectrum of fungicidal activity and exhibits preventative effects. It is active against almost all types of fungal diseases and is very effective in controlling powdery mildew, gray mold, root rot, Sclerotinia rot, and various rot diseases. It is less prone to cross-resistance and is also effective against strains resistant to other agents, and is mainly used for controlling diseases in oilseed rape, grapes, fruit trees, vegetables, and field crops.

Boscalid is expensive and carries the risk of resistance. Bacillus velezensis TCS001, as a biological pesticide, has microbicidal and disease resistance-inducing effects without resistance issues, but its efficacy in controlling strawberry gray mold is generally limited. Therefore, the combination of boscalid and Bacillus velezensis TCS001 can reduce the cost of agents for controlling strawberry gray mold, decrease the dose of boscalid, delay the development of resistance to boscalid, while also leveraging the disease resistance-inducing function of Bacillus to improve overall control efficacy.

Ash C et al. (1994) used PCR probes to identify the rRNA of some species of Bacillus and reclassified some of them into a new genus, Paenibacillus. In the Manual of Clinical Microbiology (1999) edited by Patrick R. Murray et al., those bacilli that produce swollen, elliptical spores were also subdivided from Bacillus spp, and given a new genus name, Paenibacillus. Consequently, Bacillus polymyxa was reclassified into the genus Paenibacillus spp., referred to as Paenibacillus polymyxa.

Strain HY96-2, isolated from the rhizosphere soil of tomato plants in Nanchang, is Gram-positive and acid-fast negative. After culturing at 30° C. for 2 days, the bacterial cells are straight or nearly straight rod-shaped, containing a single elliptical spore with sparse peritrichous flagella, and are motile. They exhibit aerobic growth with facultative anaerobic characteristics, producing no soluble pigment on nutrient agar. The cell wall contains meso-DAP (diaminopimelic acid) and glycine, with no characteristic sugars. Analysis of the 16S rDNA sequence showed that HY96-2 belongs to the genus Paenibacillus. The sequence homology between HY96-2 and Paenibacillus polymyxa is 99%. Paenibacillus polymyxa HY96-2 controls diseases mainly through three mechanisms: (1) Paenibacillus polymyxa HY96-2 can colonize the soil on the root surface, roots, lower stem, upper stem phloem and xylem, and leaf surface of plants, exhibiting good colonization ability in plants and controlling diseases through site competition; (2) in addition to the living cells having good microbicidal effects against pathogens, Paenibacillus polymyxa HY96-2 can also produce metabolites such as fusaricidins and phenolic acids, which exhibit good antagonistic effects against both pathogenic fungi and bacteria; (3) Paenibacillus polymyxa HY96-2 significantly increases the activities of β-1,3-glucanase, PAL, and POD in plant roots and stems, thereby inducing disease resistance in plants.

### SUMMARY

The technical problem to be solved by this disclosure is to provide a microbiocidal mixture that can not only have a synergistic effect against strawberry gray mold, but also increase the fruit weight, vitamin C, total sugar, and organic acid content of strawberries, thereby improving the quality of strawberries.

One technical solution provided by this disclosure is a microbiocidal composition containing active ingredients boscalid and Bacillus velezensis TCS001, where based on 1×10⁹ CFU/mL of Bacillus velezensis TCS001 being 100% by mass, a mass ratio of the Bacillus velezensis TCS001 to the boscalid is 100:1-1:100; preferably, the mass ratio of the Bacillus velezensis TCS001 to the boscalid is 100:1-10:1; particularly preferably, the mass ratio of the Bacillus velezensis TCS001 to the boscalid is 30:1.

A total mass of the Bacillus velezensis TCS001 and the boscalid accounts for 1-50% by mass of the microbiocidal composition; preferably, the total mass of the Bacillus velezensis TCS001 and the boscalid accounts for 5-30% by mass of the microbiocidal composition; particularly preferably, the total mass of the Bacillus velezensis TCS001 and the boscalid accounts for 10-20% by mass of the microbiocidal composition.

The microbiocidal composition can be formulated into any agriculturally acceptable formulation; preferably, the formulation of the microbiocidal composition is a suspension concentrate, a seed coating agent, a wettable powder, a water dispersible granule, a microcapsule suspension, a coated granule, a granule, a water-soluble granule, a water-soluble powder, an emulsifiable concentrate, a microemulsion, a suspoemulsion, or an emulsion in water.

The microbiocidal composition further contains one or more other active ingredients; preferably, the other active ingredients include insecticides, fungicides, herbicides, plant growth regulators, and plant immune agents.

Another technical solution provided by this disclosure is use of the microbiocidal composition for controlling pathogens in plants; preferably, the plants include cereals, fruits, vegetables, and cash crops, and the pathogens include a broad range of phytopathogenic fungi such as Plasmodiophoromycetes, Oomycetes, Chytridiomycetes, Zygomycetes, Ascomycetes, Basidiomycetes, and Deuteromycetes; particularly preferably, the pathogen is a strawberry gray mold-causing pathogen.

Another technical solution provided by this disclosure is a method for controlling pathogens in plants, including applying the microbiocidal composition to the pathogens and/or their environments, or to plants, plant parts, seeds, soil, areas, materials, or spaces.

The Bacillus velezensis TCS001 and the boscalid are applied simultaneously, separately, or successively.

Another technical solution provided by this disclosure is use of the microbiocidal composition for improving strawberry traits.

The strawberry traits include one or more of fruit weight, vitamin C, total sugar, and organic acid.

Another technical solution provided by this disclosure is a kit, where the kit includes the microbiocidal composition containing Bacillus velezensis TCS001 and boscalid.

Another technical problem to be solved by this disclosure is to provide a microbiocidal mixture that can not only have a synergistic effect against strawberry anthracnose, but also increase the number of strawberry runners, thereby improving the yield of strawberry seedlings.

One technical solution provided by this disclosure is a microbiocidal composition containing active ingredients Bacillus velezensis TCS001 and Paenibacillus polymyxa HY96-2, where based on 1×10⁹ CFU/mL of Bacillus velezensis TCS001 and 1×10⁹ CFU/mL of Paenibacillus polymyxa HY96-2 each being 100% by mass, a mass ratio of the Bacillus velezensis TCS001 to the Paenibacillus polymyxa HY96-2 is 50:1-1:50; preferably, the mass ratio of the Bacillus velezensis TCS001 to the Paenibacillus polymyxa HY96-2 is 4:1-1:4; particularly preferably, the mass ratio of the Bacillus velezensis TCS001 to the Paenibacillus polymyxa HY96-2 is 1:1.

A total mass of the Bacillus velezensis TCS001 and the Paenibacillus polymyxa HY96-2 accounts for 1-30% by mass of the microbiocidal composition; preferably, the total mass of the Bacillus velezensis TCS001 and the Paenibacillus polymyxa HY96-2 accounts for 5-25% by mass of the microbiocidal composition; particularly preferably, the total mass of the Bacillus velezensis TCS001 and the Paenibacillus polymyxa HY96-2 accounts for 10-20% by mass of the microbiocidal composition.

The microbiocidal composition can be formulated into any agriculturally acceptable formulation; preferably, the formulation of the microbiocidal composition is a suspension concentrate, a seed coating agent, a wettable powder, a water dispersible granule, a microcapsule suspension, a coated granule, a granule, a water-soluble granule, a water-soluble powder, an emulsifiable concentrate, a microemulsion, a suspoemulsion, or an emulsion in water.

The microbiocidal composition further contains one or more other active ingredients; preferably, the other active ingredients include insecticides, fungicides, herbicides, plant growth regulators, and plant immune agents.

Another technical solution provided by this disclosure is use of the microbiocidal composition for controlling pathogens in plants; preferably, the plants include cereals, fruits, vegetables, and cash crops, and the pathogens include a broad range of phytopathogenic fungi such as Chytridiomycetes, Plasmodiophoromycetes, Oomycetes, Zygomycetes, Ascomycetes, Basidiomycetes, and Deuteromycetes; particularly preferably, the pathogen is a strawberry anthracnose-causing pathogen.

Another technical solution provided by this disclosure is a method for controlling pathogens in plants, including applying the microbiocidal composition to the pathogens and/or their environments, or to plants, plant parts, seeds, soil, areas, materials, or spaces.

The Bacillus velezensis TCS001 and the Paenibacillus polymyxa HY96-2 are applied simultaneously, separately, or successively.

Another technical solution provided by this disclosure is use of the microbiocidal composition for promoting growth of strawberry seedlings and/or increasing the number of strawberry seedlings propagated.

The promotion of the growth of strawberry seedlings includes increasing the number of strawberry runners.

Another technical solution provided by this disclosure is a kit, where the kit includes the microbiocidal composition containing active ingredients Bacillus velezensis TCS001 and Paenibacillus polymyxa HY96-2.

### Beneficial Technical Effects of this Disclosure

This disclosure, through the binary combination of Bacillus velezensis TCS001 and boscalid, enables the resulting microbiocidal mixture to have a synergistic effect in controlling strawberry gray mold, and to increase the fruit weight, vitamin C, total sugar, and organic acid content of strawberries, thereby improving the quality of strawberries. It provides a novel alternative agent for controlling strawberry gray mold, which not only utilizes the disease resistance and immune function of the biological agent to improve control efficacy, but also reduces the development of resistance to boscalid.

This disclosure, through the binary combination of Bacillus velezensis TCS001 and Paenibacillus polymyxa HY96-2, enables the resulting microbiocidal mixture to have a synergistic effect in controlling strawberry anthracnose, providing a novel alternative agent for controlling strawberry anthracnose.

The microbiocidal composition provided by this disclosure can increase the number of strawberry runners, ultimately increasing the number of strawberry seedlings by 30,000 per mu (more than 90,000 per mu when TCS001 was applied, compared to more than 60,000 per mu when TCS001 was not applied).

### BRIEF DESCRIPTION OF THE DRAWINGS

FIG. 1 shows results of an affinity screening test between Bacillus velezensis TCS001 and other biocontrol bacteria;

FIG. 2 shows confrontation effects of Bacillus velezensis TCS001 and Paenibacillus polymyxa HY96-2 against strawberry anthracnose; and

FIG. 3 shows field effects after applying single agents of Bacillus velezensis TCS001, Paenibacillus polymyxa HY96-2, and a composition thereof.

### DETAILED DESCRIPTION OF THE EMBODIMENTS

### Example 1

Affinity Screening of Bacillus velezensis TCS001 and Boscalid

Preparation of Bacillus velezensis TCS001 seed culture: 1,000 mL of LB solid medium (27 mL×30 vials) and 150 mL of LB liquid medium were prepared and sterilized; a single colony of Bacillus velezensis TCS001 was inoculated into the LB liquid medium and cultured in a shaker at 25° C., 164 rpm, for 16 h.

Preparation of toxin-containing medium: technical grade boscalid was dissolved in DMF to prepare a 10% stock solution for later use, which was diluted with sterile water containing 1%. Tween-80 to 10 times the test dose; 3 mL of the agent solution was sequentially pipetted from low concentration to high concentration, added to 27 mL of LB medium, thoroughly shaken, and equally poured into two culture dishes with a diameter of 9 cm to prepare agent-containing plates at corresponding concentrations. Each treatment had 2 replicates.

Affinity screening: the shaken Bacillus velezensis TCS001 seed culture was diluted to 1×10⁶ CFU/mL; 40 μL was pipetted and spread onto the agent-containing plates and the control group plates, and incubated in a dark incubator at 28° C. The growth status of TCS001 was observed.

At a boscalid concentration of 400 mg/L, the colony count of Bacillus velezensis TCS001 was comparable to that of the blank control, indicating that boscalid is compatible with Bacillus velezensis TCS001.

### Example 2

Indoor Toxicity Determination of a Combination of Bacillus velezensis TCS001 and Boscalid Against Strawberry Gray Mold

Bacillus velezensis TCS001, boscalid, and a mixture of Bacillus velezensis TCS001 and boscalid were diluted to the test doses. Healthy strawberry fruits were used as the test material. The strawberry fruits were immersed in the agent solution for 20 s. Each treatment had 3 replicates, with 9 fruits per replicate, and all fruits were uniformly punctured to a size of 5 mm×5 mm. A spore suspension of strawberry gray mold-causing pathogen at 1*10⁵ spores/mL was prepared. After 24 h, the strawberry fruits treated with the agent solution were surface-sprayed with the spore suspension of strawberry gray mold-causing pathogen for inoculation. The strawberry fruits were placed in a high-humidity environment (RH 90-95%) and cultured at a constant temperature of 22° C. After 4 days, the lesion diameter was measured, and the inhibition rate (%) was calculated.

Inhibition rate (%)=(Diameter of colony in blank control−Diameter of colony in treatment)/Diameter of colony in blank control×100.

$${E}_{0} = ( X + Y ) - X \times Y / 100$$

X: inhibition rate of A at a dose of P;
Y: inhibition rate of B at a dose of Q;
E₀: theoretical inhibition rate of A+B at a dose of (P+Q); and
E: actual inhibition rate of each treatment.

The Colby method was used to evaluate the synergistic effect of the combination. When E−E₀>5%, a synergistic effect was indicated; when E−E₀<−5%, an antagonistic effect was indicated; when the value of E−E₀ was within ±5%, an additive effect was indicated.

As shown in Table 1, the inhibitory effect of the composition containing boscalid and Bacillus velezensis TCS001 against the strawberry gray mold-causing pathogen was significantly better than that of boscalid or Bacillus velezensis TCS001 alone, indicating a synergistic effect between boscalid and Bacillus velezensis TCS001. When Bacillus velezensis TCS001 and boscalid were used alone, the inhibition rates against the strawberry gray mold-causing pathogen were only 32.97% and 34.44%-79.26%, respectively; when the two were mixed, the inhibition rate against the strawberry gray mold-causing pathogen increased significantly; when the ratio of boscalid to Bacillus velezensis TCS001 was 1:6 to 1:100, the inhibition rates against the strawberry gray mold-causing pathogen ranged from 61.48% to 87.41%, all showing a synergistic effect, but the synergistic effect varied with different ratios, with the most significant synergistic effect observed at a ratio of 1:30.

TABLE 1
Indoor Toxicity Determination of a Combination of Bacillus velezensis
TCS001 and Boscalid Against Strawberry Gray Mold

| | | | | Actual | Theoretical | |
|---|---|---|---|---|---|---|
| | | | Lesion | Inhibition | Inhibition | Toxicity |
| | Treatment | | Diameter | Rate E | Rate E₀ | Ratio |
| Test Agent | Concentration/Ratio | | (cm) | (%) | (%) | E − E₀ |
| Blank control | / | | 2.70 | / | / | / |
| Bacillus velezensis TCS001 | 1 × 10⁶ | CFU/g | 1.81 | 32.96 | / | / |
| Boscalid | 160 | mg/L | 0.56 | 79.26 | / | / |
| | 100 | mg/L | 0.85 | 68.52 | / | / |
| | 50 | mg/L | 0.99 | 63.33 | / | / |
| | 33 | mg/L | 1.04 | 61.48 | / | / |
| | 25 | mg/L | 1.14 | 57.78 | / | / |
| | 16 | mg/L | 1.66 | 38.52 | / | / |
| | 12.5 | mg/L | 1.73 | 35.93 | / | / |
| | 10 | mg/L | 1.77 | 34.44 | / | / |

| | | | | | |
|---|---|---|---|---|---|
| Boscalid:Bacillus velezensis | 1:6 | 0.34 | 87.41 | 86.10 | 1.31 |
| TCS001 | 1:10 | 0.39 | 85.56 | 78.90 | 6.66 |
| | 1:20 | 0.46 | 82.96 | 75.42 | 7.54 |
| | 1:30 | 0.44 | 83.70 | 74.18 | 9.52 |
| | 1:40 | 0.53 | 80.37 | 71.70 | 8.67 |
| | 1:60 | 0.92 | 65.93 | 58.78 | 7.15 |
| | 1:80 | 0.98 | 63.70 | 57.05 | 6.64 |
| | 1:100 | 1.04 | 61.48 | 56.05 | 5.41 |

### Example 3

Field Efficacy Test of a Combination of Bacillus velezensis TCS001 and Boscalid for Controlling Strawberry Gray Mold

A field test of Bacillus velezensis TCS001 and boscalid combined at a weight ratio was conducted to verify the efficacy against gray mold in strawberries of the Benihoppe variety. The plots were arranged in a randomized block design, with a plot area of 10 m², and each treatment was repeated 3 times. The agent was applied twice during the strawberry flowering stage, once before the onset of gray mold, and once 7 to 10 days later, for a total of 2 applications. During the investigation, five points were sampled diagonally in each plot, with 50 strawberry fruits taken from each point. The number of diseased fruits was counted, and the total number of fruits and the number of diseased fruits were recorded separately. The control efficacy was calculated by the following formula. At the same time, 20 mature fruits were harvested for each treatment, the weight per fruit was measured, and the total sugar, organic acid, and vitamin C contents of the strawberries were determined.

$$Disease incidence ( \% ) = \frac{Number of diseased fruits}{Total number of investigated fruits} \times 100 \qquad ( 1 )$$

$$Control efficacy ( \% ) = \frac{\begin{matrix}Disease incidence in blank control area after agent \\ application - Disease incidence in treatment area \\ after agent application\end{matrix}}{\begin{matrix}Disease incidence in blank control area after agent \\ application\end{matrix}} \times 100 \qquad ( 2 )$$

As shown in Table 2, the combination of Bacillus velezensis TCS001 and boscalid exhibited excellent control efficacy against strawberry gray mold, reaching 85.29% to 89.70%, which was significantly better than those of boscalid alone and Bacillus velezensis TCS001 alone, showing a significant synergistic effect. When the ratio of boscalid to Bacillus velezensis TCS001 was 1:30, the highest control efficacy of 89.70% was achieved, which was consistent with the indoor results.

TABLE 2
Field Test Results of a Combination of Bacillus velezensis
TCS001 and Boscalid for Controlling Strawberry Gray Mold

| | | | Disease | Control |
|---|---|---|---|---|
| | | | Incidence | Efficacy |
| Agent | Treatment Dose | | (%) | (%) |
| 50% Boscalid Water Dispersible | 30 g/mu + 600 mL/mu | | 5.33 | 85.29 |
| Granule + 1 × 10⁹ CFU/mL Bacillus | (Boscalid:TCS001 = 1:40) | | | |
| velezensis TCS001 Suspension | 30 g/mu + 450 mL/mu | | 3.73 | 89.70 |
| Concentrate | (Boscalid:TCS001 = 1:30) | | | |
| | 30 g/mu + 300 mL/mu | | 4.53 | 87.50 |
| | (Boscalid:TCS001 = 1:20) | | | |
| | 30 g/mu + 150 mL/mu | | 5.06 | 86.07 |
| | (Boscalid:TCS001 = 1:10) | | | |
| | 30 g/mu + 90 mL/mu | | 5.20 | 85.66 |
| | (Boscalid:TCS001 = 1:6) | | | |
| 50% Boscalid Water Dispersible | 45 | g/mu | 8.27 | 77.20 |
| Granule | 30 | g/mu | 11.60 | 68.01 |
| 1 × 10⁹ CFU/mL Bacillus velezensis | 450 | mL/mu | 27.87 | 23.15 |

| | | | |
|---|---|---|---|
| TCS001 Suspension Concentrate | | | |
| Blank control | / | 36.27 | / |

As shown in Table 3, while the combination of boscalid and Bacillus velezensis TCS001 exhibited excellent control efficacy against strawberry gray mold, it also increased the weight per fruit and total sugar, vitamin C, and organic acid contents of strawberries, improved yield and quality, and contributed to a better taste. When the ratio of boscalid to Bacillus velezensis TCS001 was 1:6 to 1:40, the weight per fruit and total sugar, vitamin C, and organic acid contents of strawberries were all higher than those in the blank control and the boscalid treatment.

TABLE 3
Effect of a Combination of Boscalid and Bacillus velezensis
TCS001 on the Quality of Strawberries

| | | | Weight | | Organic | Total |
|---|---|---|---|---|---|---|
| | | | per Fruit | Vitamin C | Acid | Sugar |
| Agent | Treatment Dose | | (g) | (mg/100 g) | (g/kg) | (g/100 g) |
| 50% Boscalid Water | 30 g/mu + 600 | | 43.48a | 57.400a | 7.630ab | 10.71a |
| Dispersible Granule + | mL/mu (1:40) | | | | | |
| 1 × 10⁹ CFU/mL Bacillus | 30 g/mu + 450 | | 43.27a | 57.033a | 7.643a | 10.506a |
| velezensis TCS001 | mL/mu (1:30) | | | | | |
| Suspension Concentrate | 30 g/mu + 300 | | 43.33a | 57.033a | 7.510abc | 10.63a |
| (Boscalid:TCS001) | mL/mu (1:20) | | | | | |
| | 30 g/mu + 150 | | 43.325a | 57.533a | 7.513abc | 10.69a |
| | mL/mu (1:10) | | | | | |
| | 30 g/mu + 90 | | 43.055ab | 57.266a | 7.473abc | 10.67a |
| | mL/mu (1:6) | | | | | |
| 50% Boscalid Water | 45 | g/mu | 41.275c | 54.9c | 7.330cde | 10.44a |
| Dispersible Granule | 30 | g/mu | 41.02c | 54.8c | 7.276de | 10.43a |
| 1 × 10⁹ CFU/mL Bacillus | 450 | mL/mu | 43.33a | 57a | 7.533ab | 10.593a |

| | | | | | |
|---|---|---|---|---|---|
| velezensis TCS001 | | | | | |
| Suspension Concentrate | | | | | |
| Blank control | / | 40.655c | 55.566bc | 7.326cde | 10.503a |

### Example 4

Affinity Screening of Bacillus velezensis TCS001 with Paenibacillus polymyxa HY96-2, Bacillus subtilis, Bacillus amyloliquefaciens, and Empedobacter brevis

Bacillus velezensis TCS001, Paenibacillus polymyxa HY96-2, Bacillus subtilis, Bacillus amyloliquefaciens, and Empedobacter brevis were streaked on LB plate media respectively, and cultured at 28° C. in constant temperature darkness for 48 h to obtain single colonies. A single colony of the biocontrol strain activated for 2 days was picked with an inoculation loop, and inoculated into MLB in a 250 ml conical flask with a liquid volume of 150 mL, and cultured in a shaker at 25° C., 164 r/min for 24 h. The bacterial suspension was adjusted with physiological saline or sterile water to an OD₆₃₀ value of 0.1. 100 μL of the Bacillus velezensis TCS001 bacterial suspension (plate strain) was pipetted onto an LB medium plate and spread evenly using a triangular spreader. Sterile filter paper discs (d=5 mm) were placed into the other biocontrol bacterial suspensions (test strains), soaked for 10 s, and then placed on the plate coated with the plate bacterial solution at the four vertices of a square 30 mm from the center of the medium. A sterile filter paper disc soaked in sterile water for 10 s was placed at the center of the plate as a control. Each treatment was repeated 3 times. After film sealing, the plates were placed in a constant temperature incubator at 28° C. for dark culture, and observed for the formation of inhibition zones. The presence of an inhibition zone indicates incompatibility between the strains, while the absence of an inhibition zone indicates compatibility between the strains.

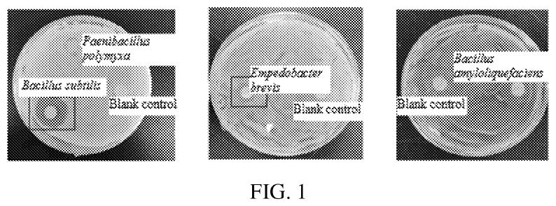

The results of the affinity screening test between Bacillus velezensis TCS001 and the biocontrol bacteria are shown in FIG. 1. No inhibition zones appeared around the filter paper discs of Paenibacillus polymyxa HY96-2 and Bacillus amyloliquefaciens, indicating that Bacillus velezensis TCS001 is compatible with Paenibacillus polymyxa HY96-2 and Bacillus amyloliquefaciens. Inhibition zones appeared around the filter paper discs of Bacillus subtilis and Empedobacter brevis, indicating that Bacillus velezensis TCS001 is incompatible with Bacillus subtilis and Empedobacter brevis.

### Example 5

Confrontation Test of Bacillus velezensis TCS001 and Paenibacillus polymyxa HY96-2 Against Strawberry Anthracnose

A vigorously growing strawberry anthracnose pathogen mycelial plug with a diameter of 5 mm was inoculated into the center of a PDA plate, with the mycelial side facing down. At a distance of 2 cm from the pathogen, 4 single colonies of Bacillus velezensis TCS001 and Paenibacillus polymyxa HY96-2 were symmetrically inoculated at the top, bottom, left, and right positions. A plate without inoculated single colonies of biocontrol bacteria was used as a control. Each treatment was repeated 3 times. The plates were incubated upside down in darkness at 26° C. When the diameter of the pathogen in the control group reached ¾ of the diameter of the culture dish, the diameter of the pathogen colony was measured using the cross method.

Inhibition rate calculation formula: Inhibition rate %=(Colony diameter of control group−Colony diameter of treatment group)/(Colony diameter of control group−5)×100.

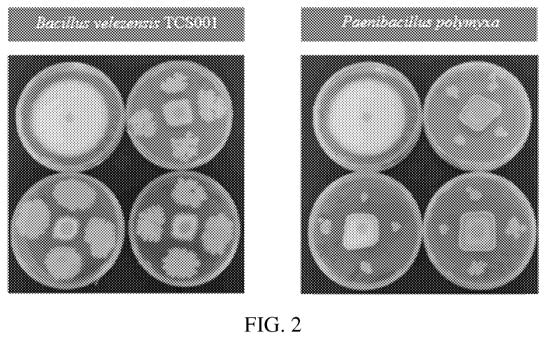

Test results (FIG. 2): the inhibition rates of Bacillus velezensis TCS001 and Paenibacillus polymyxa HY96-2 against the strawberry anthracnose pathogen were 72.18% and 63.36%, respectively.

### Example 6

Screening of a Combination Formulation of Bacillus velezensis TCS001 and Paenibacillus polymyxa HY96-2 for Controlling Strawberry Anthracnose

Strawberry seedlings with uniform growth in plug trays were selected for transplanting. The strawberry stems were inoculated during transplanting by puncturing the base of the stem with a sterilized needle, and then the prepared spore suspension was sprayed onto the punctured site. The agent was applied 24 h after inoculation. Each treatment was repeated 3 times, with 10 strawberry seedlings per replicate, and each seedling had 3 unfolded leaves.

The disease severity grading standard was based on the main stem:
Grade 0: no disease;
Grade 1: lesion area encircling less than 5% of the entire main stem;
Grade 3: lesion area encircling 6%-10% of the entire main stem;
Grade 5: lesion area encircling 11%-25% of the entire main stem;
Grade 7: lesion area encircling 26%-50% of the entire main stem; and
Grade 9: lesion area encircling more than 51% of the entire main stem, or died plant.

Efficacy calculation method: the efficacy was calculated according to the following formulas.

$$Disease index = \frac{\begin{matrix}\sum [ Number of diseased leaves at each grade \times \\ Relative grade value ]\end{matrix}}{Total number of leaves investigated \times 9} \times 100$$

$$Control efficacy ( \% ) = \frac{\begin{matrix}Disease index in blank control after agent application - \\ Disease index in treatment after agent application\end{matrix}}{Disease index in blank control after agent application} \times 100$$

Theoretical mixed toxicity index (TTI)=Toxicity index of A×Content of A in the mixture (%)+Toxicity index of B×Content of B in the mixture (%)

$$Actual ( mixed ) toxicity index ( ATI ) = \frac{{LC}_{50} of standard agent}{{LC}_{50} of test agent ( mixture )} \times 100$$

$$Co - toxicity coefficient ( CTC ) = \frac{Actual mixed toxicity index ( ATI )}{Theoretical mixed toxicity index ( TTI )} \times 100$$

If the co-toxicity coefficient is greater than 120, it indicates a synergistic effect; if it is less than 80, it indicates an antagonistic effect; if it is greater than 80 but less than 120, it indicates an additive effect.

TABLE 4
Screening of a Combination Formulation of Bacillus velezensis
TCS001 and Paenibacillus polymyxa HY96-2 for
Controlling Strawberry Anthracnose

| | | Median | |
|---|---|---|---|
| | | Effective | |
| Ratio | Regression Equation | Concentration | Co-toxicity |
| (TCS001:HY96-2) | Y = a + bx | EC₅₀ (mg/L) | Coefficient |
| 50:1 | Y = 3.272 + 1.159x | 30.960 | 106.79 |
| 10:1 | Y = 2.296 + 1.820x | 30.604 | 107.75 |
| 4:1 | Y = 2.729 + 1.619x | 25.301 | 129.83 |
| 3:1 | Y = 2.703 + 1.677x | 23.434 | 139.92 |
| 2:1 | Y = 3.126 + 1.396x | 21.975 | 148.77 |
| 1:1 | Y = 3.124 + 1.428x | 20.580 | 157.91 |
| 1:2 | Y = 3.011 + 1.470x | 22.527 | 143.41 |
| 1:3 | Y = 3.005 + 1.432x | 24.734 | 130.23 |
| 1:4 | Y = 2.757 + 1.579x | 26.350 | 122.03 |
| 1:50 | Y = 2.412 + 1.654x | 36.712 | 87.04 |
| 1:0 | Y = 2.762 + 1.473x | 33.085 | — |
| 0:1 | Y = 2.679 + 1.543x | 31.931 | — |

The test results (Table 4) showed that the mixture of Bacillus velezensis TCS001 and Paenibacillus polymyxa HY96-2 exhibited high activity against the tested target. When the ratio of Bacillus velezensis TCS001 to Paenibacillus polymyxa HY96-2 was 50:1, 10:1, and 1:50, an additive effect was observed; when the ratio of Bacillus velezensis TCS001 to Paenibacillus polymyxa HY96-2 was 4:1 to 1:4, the co-toxicity coefficients ranged from 122.03 to 157.91, indicating a significant synergistic effect; when the ratio was 1:1, the co-toxicity coefficient was 157.91, indicating the most significant synergistic effect.

### Example 7

Field Efficacy Test of a Mixture of Bacillus velezensis TCS001 and Paenibacillus polymyxa HY96-2 for Controlling Strawberry Anthracnose During Seedling Raising Stage

The test was conducted on strawberries of the Benihoppe variety cultivated in Banqiao Village, Lin'an District, Hangzhou City. During the seedling raising stage of the strawberries, the agent was first applied before the onset of anthracnose, with subsequent applications every 7-10 days, for a total of 10 applications. The consumed water volume was 30 L per mu. Each plot was 50 m², and each treatment was repeated 3 times. The control efficacy was investigated 7-10 days after the final application. The investigation was conducted according to GB/T 17980.112-2004 Pesticide—Guidelines for the field efficacy trials (II)—Part 112: Fungicides against anthracnose of cucurbits. Five sampling points were taken per plot, with 5 plants investigated at each point, totaling 25 plants. The incidence of disease on the main stems and runners of strawberries in each plot was investigated, and the control efficacy was calculated. The disease severity grading standard was based on the main stem and runners:
Grade 0: no disease;
Grade 1: lesion area encircling less than 5% of the entire main stem and runners;
Grade 3: lesion area encircling 6%-10% of the entire main stem and runners;
Grade 5: lesion area encircling 11%-25% of the entire main stem and runners;
Grade 7: lesion area encircling 26%-50% of the entire main stem and runners; and
Grade 9: lesion area encircling more than 51% of the entire main stem and runners, or died plant.

Efficacy calculation method: the efficacy was calculated according to the following formulas.

$$Disease index = \frac{\begin{matrix}\sum [ Number of diseased leaves at each grade \times \\ Relative grade value ]\end{matrix}}{Total number of leaves investigated \times 9} \times 100$$

$$Control efficacy ( \% ) = \frac{\begin{matrix}Disease index in blank control after agent application - \\ Disease index in treatment after agent application\end{matrix}}{Disease index in blank control after agent application} \times 100$$

TABLE 5
Field Efficacy Test Results of Bacillus velezensis
TCS001, Paenibacillus polymyxa HY96-2, and a Mixture
thereof for Controlling Strawberry Anthracnose

| | | | Control |
|---|---|---|---|
| | Treatment | Disease | Efficacy |
| Agent | (g/mu) | index | (%) |
| 2 × 10⁹ CFU/mL Bacillus velezensis | 200 (4:1) | 7.64 | 85.88 |
| TCS001•Paenibacillus polymyxa | 200 (3:1) | 9.14 | 83.11 |
| HY96-2 | 200 (2:1) | 7.12 | 86.84 |
| | 200 (1:1) | 6.43 | 88.12 |
| | 200 (1:2) | 7.69 | 85.79 |
| | 200 (1:3) | 7.90 | 85.40 |
| | 200 (1:4) | 9.67 | 82.13 |
| 1 × 10⁹ CFU/mL Bacillus velezensis | 250 | 12.54 | 76.82 |
| TCS001 | | | |
| 1 × 10⁹ CFU/mL Paenibacillus | 250 | 14.48 | 73.24 |
| polymyxa HY96-2 | | | |
| 10% Difenoconazole Water | 80 | 24.65 | 54.44 |
| Dispersible Granule | | | |
| Blank control | — | 54.11 | — |

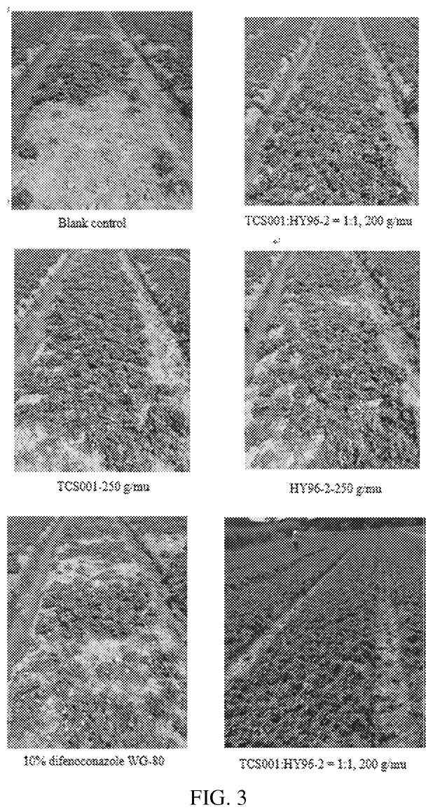

Test Results (Table 6 and FIG. 3): 10 days after the final application, the control efficacy of the mixture of Bacillus velezensis TCS001 and Paenibacillus polymyxa HY96-2 (TCS001: HY96-2=4:1, 3:1, 2:1, 1:1, 1:2, 1:3, and 1:4) at a dose of 200 g/mu was 85.88%, 83.11%, 86.84%, 88.12%, 85.79%, 85.40%, and 82.13%, respectively, which was significantly higher than the control efficacy of the two single agents, namely 1×10⁹ CFU/mL Bacillus velezensis TCS001 and 1×10⁹ CFU/mL Paenibacillus polymyxa HY96-2 at a dose of 250 g/mu, and was particularly superior to the control efficacy of the chemical agent 10% difenoconazole water dispersible granule at 80 g/mu. When the ratio of Bacillus velezensis TCS001 to Paenibacillus polymyxa HY96-2 was 1:1, the highest control efficacy of 88.17% was achieved. The control efficacy of the single agents, namely 1×10⁹ CFU/mL Bacillus velezensis TCS001 and 1×10⁹ CFU/mL Paenibacillus polymyxa HY96-2 at a dose of 250 g/mu, was 76.82% and 73.24%, respectively, which was significantly higher than the control efficacy of 10% difenoconazole water dispersible granule at 80 g/mu (54.44%).

During the test period, no adverse effects of the test agents on other pests and diseases or non-target organisms were observed, and they were safe for strawberries and bees.

Additionally, it was found during the test that Bacillus velezensis TCS001, Paenibacillus polymyxa HY96-2, and the mixture thereof could increase the number of strawberry runners and seedlings. When the average number of runners per plant in the blank control was 2.27, the number of runners in the treatment with 10% difenoconazole water dispersible granule was 2.20, whereas Bacillus velezensis TCS001, Paenibacillus polymyxa HY96-2, and the mixture thereof increased the number of strawberry runners to 3.18-3.73. When the ratio of Bacillus velezensis TCS001 to Paenibacillus polymyxa HY96-2 in the mixture was 1:1, the number of runners reached the highest, with an increase rate of 64.32%.

At the final harvest in the demonstration area, it was measured that the number of strawberry seedlings increased by 30,000 per mu (more than 90,000 per mu when TCS001 was applied, compared to more than 60,000 per mu when TCS001 was not applied).

TABLE 6
Effect of Bacillus velezensis TCS001, Paenibacillus polymyxa
HY96-2, and a Mixture thereof on Strawberry Runners

| | Treatment | Number of Runners | Runner Increase |
|---|---|---|---|
| Agent | (g/mu) | (plants) | Rate (%) |
| 2 × 10⁹ CFU/mL Bacillus velezensis | 200 (4:1) | 3.33 | 46.70 |
| TCS001•Paenibacillus polymyxa | 200 (3:1) | 3.43 | 51.10 |
| HY96-2 | 200 (2:1) | 3.67 | 61.67 |
| | 200 (1:1) | 3.73 | 64.32 |
| | 200 (1:2) | 3.47 | 52.86 |
| | 200 (1:3) | 3.43 | 51.10 |
| | 200 (1:4) | 3.27 | 44.05 |
| 1 × 10⁹ CFU/mL Bacillus velezensis | 250 | 3.53 | 55.51 |
| TCS001 | | | |
| 1 × 10⁹ CFU/mL Paenibacillus | 250 | 3.18 | 40.09 |
| polymyxa HY96-2 | | | |
| 10% Difenoconazole Water | 80 | 2.20 | −3.08 |
| Dispersible Granule | | | |
| Blank control | — | 2.27 | / |

In the foregoing embodiments, the purposes, technical solutions, and beneficial effects of this disclosure are further described in detail. It should be understood that the above merely describes the embodiments of this disclosure and is not intended to limit the scope of protection of this disclosure. Any modifications, equivalent substitutions, or improvements made without departing from the spirit and principle of this disclosure shall fall within the scope of protection of this disclosure.

What is claimed is:

1. A microbiocidal composition containing Bacillus velezensis TCS001 and boscalid, wherein based on a Bacillus velezensis TCS001 preparation at a concentration of 1×10⁹ CFU/mL being 100% by mass, a mass ratio of the Bacillus velezensis TCS001 to the boscalid is 6:1 to 100:1.

2. The microbiocidal composition according to claim 1, wherein the mass ratio of the Bacillus velezensis TCS001 to the boscalid is 10:1 to 100:1.

3. The microbiocidal composition according to claim 2, wherein the mass ratio of the Bacillus velezensis TCS001 to the boscalid is 30:1.

4. The microbiocidal composition according to claim 1, wherein a total mass of the Bacillus velezensis TCS001 and the boscalid accounts for 5 wt % to 30 wt % of a total mass of the composition.

5. The microbiocidal composition according to claim 4, wherein the total mass of the Bacillus velezensis TCS001 and the boscalid accounts for 10 wt % to 20 wt % of the total mass of the composition.

6. The microbiocidal composition according to claim 1, wherein a formulation of the microbiocidal composition is selected from: a suspension concentrate, a seed coating agent, a wettable powder, a water dispersible granule, a microcapsule suspension, a coated granule, a granule, a water-soluble granule, a water-soluble powder, an aqueous solution, an emulsifiable concentrate, a microemulsion, a suspoemulsion, and an emulsion in water.

7. The microbiocidal composition according to claim 1, wherein the microbiocidal composition is used for controlling strawberry gray mold.

8. The microbiocidal composition according to claim 1, wherein the microbiocidal composition is used for increasing the weight of strawberry fruits.

9. The microbiocidal composition according to claim 1, wherein the microbiocidal composition is used for increasing vitamin C content in strawberry fruits.

10. The microbiocidal composition according to claim 1, wherein the microbiocidal composition is used for increasing total sugar content in strawberry fruits.

11. The microbiocidal composition according to claim 1, wherein the microbiocidal composition is used for regulating organic acid content in strawberry fruits.

12. The microbiocidal composition according to claim 1, wherein the microbiocidal composition is used for delaying or reducing development of resistance to the boscalid.
